(19) United States
(12) Patent Application Publication
(10) Pub. No.: US 2006/0182837 A1
(43) Pub. Date: Aug. 17, 2006

(54) Positive displacement heatstake apparatus and method thereof

(76) Inventor: Carlton Hunt Trinkle, Union, KY (US)

Correspondence Address: WOOD, HERRON & EVANS, LLP, 2700 CAREW TOWER, 441 VINE STREET, CINCINNATI, OH, 45202, US

(21) Appl. No.: 11/058,705

(22) Filed: Feb. 15, 2005

(51) Int. Cl. B29C 65/18

(52) U.S. Cl. 425/383; 425/403; 264/249

(57) ABSTRACT

A heat staking method and apparatus for deforming thermoplastic parts and joining thermoplastic and dissimilar material parts to form an assembly is featured.

### BACKGROUND

This present invention relates generally to heat staking machines, and is particularly directed to a positive displacement heat staking apparatus and the method of deforming thermoplastic using that apparatus. The literal definition of staking is the process of melting and reforming a thermoplastic post to lock it in place mechanically with a dissimilar material. Some of the most common thermoplastic materials include, but are not limited to ABS, polypropylene, polycarbonate, semi-crystallines, polymers, ABS/polycarbonate blends, and many engineering materials (even with as much as 30% filler). In the broadest sense, heat staking apparatuses are used to permanently fuse together a molded piece and metal assembly with a better torque strength than can be achieved with a simple threading technique. Common combinations include, but are not limited to, plastic to metal, rubber, glass or wood fiber products.

For instance, almost every motor vehicle today has one or more heat staked plastic components. Plastic offers the structural strength of steel by virtue of its greater elasticity, and if damage is incurred, it is capable of repair by welding with no loss of component strength. Cracks, splits, warping and even the loss of material can be remedied in this and other industries with the aid of a hot air or hot heat staking piece of equipment. Where a steel component with equivalent damage would be renewed at some cost, the repair of the plastic part can save time and expense, particularly when winter accident periods place great demands on the repair parts stock. A plastic component can be quickly restored to an “as new” condition without the need for fillers or special treatments.

Heat staking apparatuses can take a wide variety of shapes, sizes and forms. For example, some heat staking apparatuses have rotational table surfaces, some require the introduction of cold air, some utilize fiber optics, and some involve heat insertion technologies. No one, however, has previously made or used a heat staking apparatus in accordance with the present invention.

### SUMMARY OF THE INVENTION

With conventional heat staking, hot air is utilized. This form of heat staking is usually done with hot air blowing directly on the plastic and a cold probe with a shape of a head to be formed in the end. It is important to evenly heat the plastic post. This is usually very difficult since using one hot air gun with very low temperature control causes air to blow from one side. After the plastic has been heated, the cold probe approaches and quickly forms the head by smashing the molten metal. It works well if the material has been evenly heated and the plastic post is not too long. If the post is too long, it is often just folded over instead of reforming the material to the shape in the end of the cold pin.

With a conventional process to heat the plastic to be formed, compressed air is heated and blown directly onto the component via an end-line heater. All process parameters are accurately controlled and adjustable for each modular staking head. Precise heat and pressure are critical to reform these thermoplastic posts. Conventional heat staking often provides inconsistent results due to the molten plastic sticking to the hot staking tool.

The present invention addresses these and other problems in the prior art, by providing a heat staking device with faster processing time, more precise staking results, and positively ejected thermoplastic parts, amongst other novel features.

A general object of this invention is to provide a heating system with a mold or cradle that holds a thermoplastic part, a staking portion, including a pin assembly, that comes over the entire post of the thermoplastic part and heats it uniformly and all at once, from top to bottom. This staking portion is operationally in concert with an actuator portion, that moves the staking portion towards and away from the thermoplastic part. When a molding pin of the pin assembly comes down onto the thermoplastic part during the heat staking cycle, it forces the material into the shape of the head. During this entire cycle, the mold or cradle positively contains the plastic in the desired shape.

Another object of the invention is to utilize a plurality of ejector pins for stabilizing and holding in-place the thermoplastic part during the staking cycle, and yet further, the ejector pins are instrumental for positively ejecting the part once the staking cycle is complete, and the actuator portion returns to its starting position.

Yet another object of the invention is to provide a significantly faster system. The present invention allows an operator to bring the apparatus toward the thermoplastic part, heat the post within a few seconds maximum, and then stake. While some applications actually deform plastic without even heating, the present invention gives a well defined, usable head, using positive displacement and a controlled staking cycle.

Next, the ejector pin holds the part and head in place while the mold or cradle lifts away. This is a significant improvement over the current processes because the present invention provides positive ejection of the head from the mold or cradle. If desired, this positive displacement ejection process provides an ideal opportunity to blow cold air directly on the plastic head before the injector pin pulls away. This virtually eliminates the possibility of a pulled off head.

Other objects, features and advantages of the present invention will become apparent to those skilled in the art by reference to the following detailed description, which is by way of illustration, one of the best modes contemplated for carrying out the invention. As will be realized, the invention is capable of other different and obvious aspects, all with out departing from the invention. Accordingly, the drawings should be regarded as illustrative in nature and not restrictive.

These objects are achieved using a positive displacement heat staking apparatus which comprises an actuator cylinder portion selectively actuable to produce movement toward and away from the thermoplastic part during a staking cycle, a staking portion responsive to the actuator cylinder portion, the staking portion comprising an elongate housing coupled to the actuator portion and including a channel slot, a sliding tube portion received by the elongate housing, the sliding tube portion having a first end and a second end and including a receiving means; a pin assembly portion, a staking cylinder longitudinally engaging the pin assembly portion; wherein the staking cylinder moves in concert with actuator cylinder portion during the staking cycle; a cradle for orienting and supporting the thermoplastic part; an actuator mount for connecting the actuator cylinder portion to the staking portion, in communication through the receiving means through the channel slot, whereby the pin assembly portion is slidably moveable along an axis toward and away from the thermoplastic part within the cradle; a retaining clip located near the second end of the sliding tube portion, and a heating source, for heating a portion of the thermoplastic part.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention, in which:

FIG. 1 illustrates an example of the heat stake apparatus of the present invention.

FIG. 2 illustrates another example of the invention, in cross section, with the staking portion in home position, over a post of a thermoplastic part.

FIG. 3 is a cross sectional view of the invention of FIG. 1 with the staking portion lowered about the post of the thermoplastic part.

FIG. 4 is a cross sectional view of the invention of FIG. 1 with the molding pin pressed into the post portion of the thermoplastic part.

FIG. 5 is a cross sectional view of the invention of FIG. 1 with the ejector pin retracted, the thermoplastic part positively ejected, and the apparatus in a final home position or resting state.

Reference will now be made in detail to the present preferred embodiment of the invention, an example of which is illustrated in the accompanying drawings.

### DETAILED DESCRIPTION OF THE INVENTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, the invention will now be described.

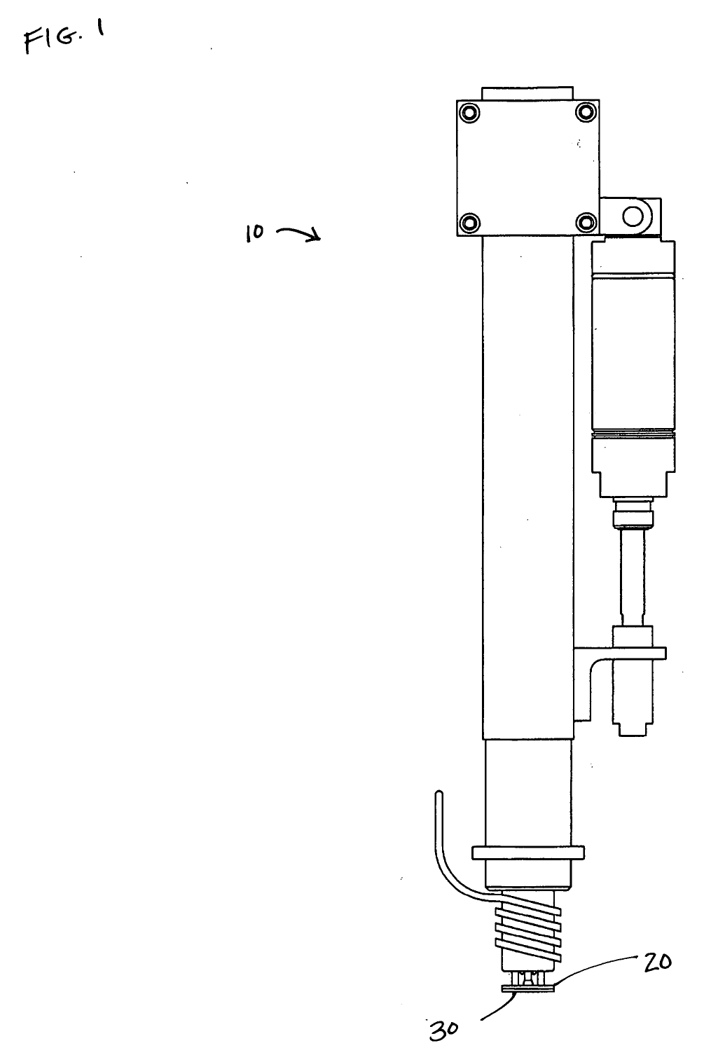

Referring now to FIG. 1, a heat staking apparatus 10 according to the present invention is shown positioned above a thermoplastic part 20. The thermoplastic part 20 is oriented in the cradle 30 portion of the heat staking apparatus 10. As is well known in the art, a post 22 formed of a thermoplastic material projects upwardly from the cradle 30. This new heat staking apparatus 10 works with just about any shape and length of post 22. The post 22 is the portion that may be deformed into a head shape.

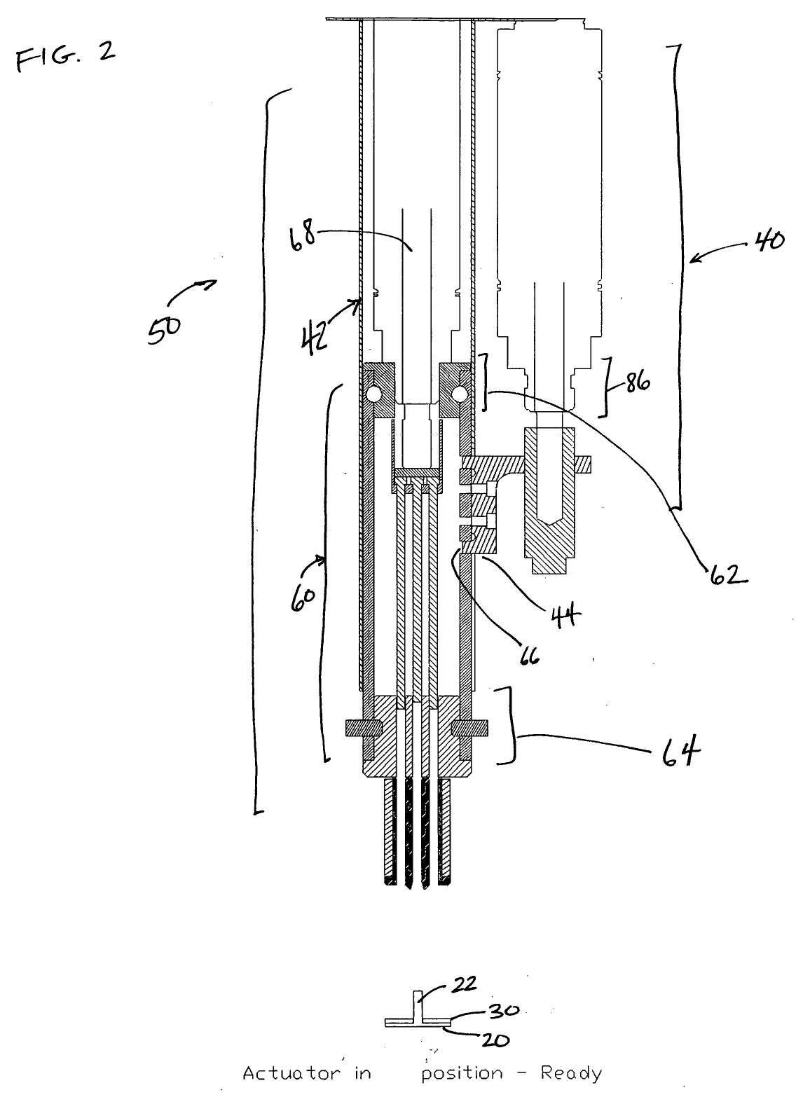

Turning now to FIG. 2, an actuator cylinder portion 40 is selectively actuable and operatively connected to a staking portion 50. The actuator cylinder portion 40 produces movement toward and away from the thermoplastic part 20 during a staking cycle. The staking portion 50 is responsive to the actuator cylinder portion 40, and includes an elongate housing 42 made of a material like stainless steel, is coupled to the actuator cylinder portion 40 and has a channel slot 44, and a sliding tube portion 60 received by the elongate housing 42.

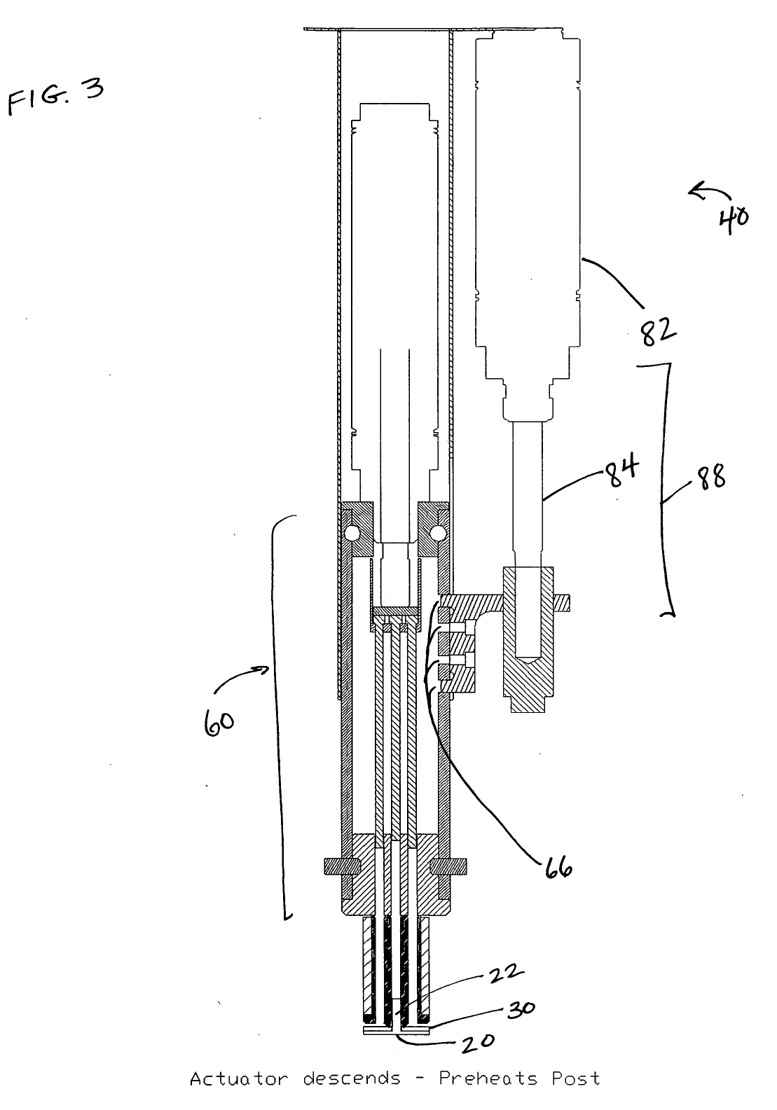

The sliding tube portion 60 has a first end 62 and a second end 64, and includes a receiving means 66, a pin assembly portion 70, and a staking cylinder 68 longitudinally engaging the pin assembly portion 70. The staking cylinder 68 moves in concert with the actuator cylinder portion 40 during a staking cycle. The actuator cylinder portion 40 is connected to and in communication, via the channel slot 44, with the staking portion 50 through its receiving means 66, as further illustrated in FIG. 3.

Again, referring to FIG. 3, the actuator cylinder portion 40 is defined by a cylinder 82 and rod 84 operatively connected to the sliding tube portion 60, the rod 84 being moveable between a first or home position 86 (shown in FIG. 2), in which the sliding tube portion 60 is in a first or home position 86, away from the thermoplastic part 20 within the cradle 30; and a second or lowered position 88, in which the sliding tube portion 60 is placed in a second or lowered position 88 toward or in contact with a thermoplastic part 20 within the cradle 30. The cylinder 82 may be pneumatic or hydraulic.

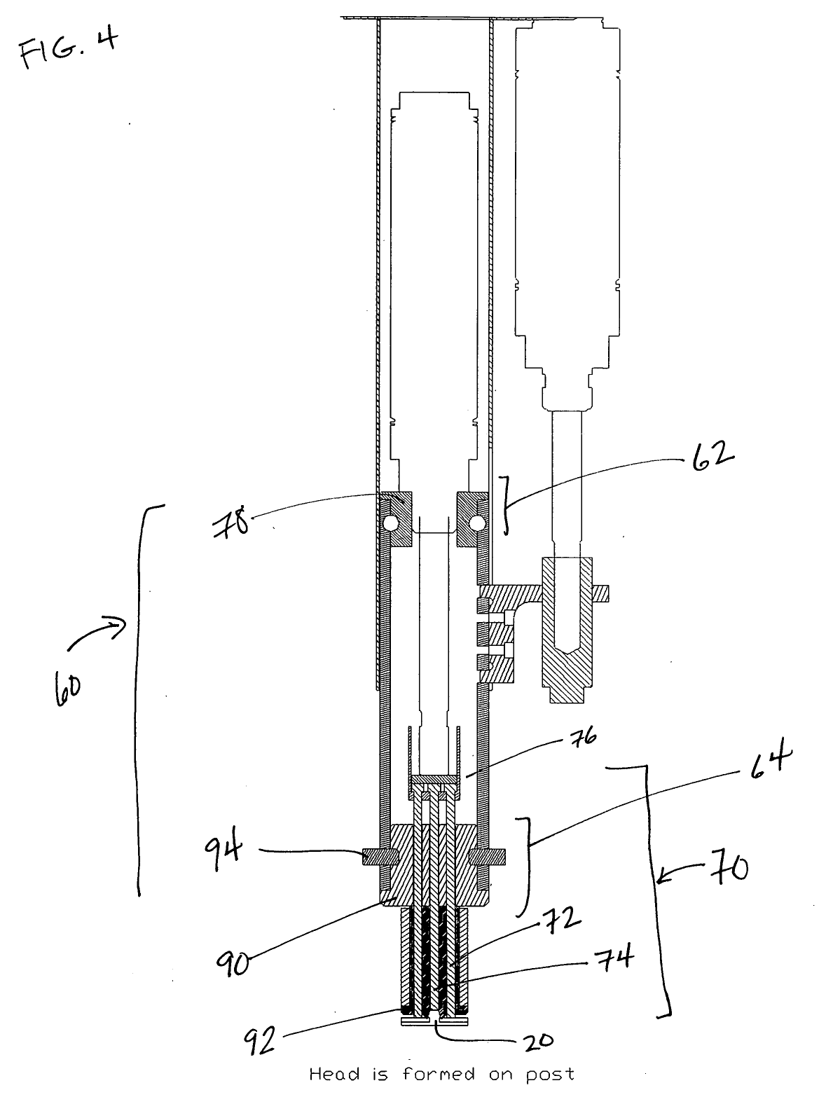

Turning now to FIG. 4, the pin assembly portion 70 is defined by a plurality of ejector pins 72 oriented to engage, stabilize, and eject the thermoplastic part 20 after a staking cycle. FIG. 4 further illustrates that the pin assembly portion 70 has at least one molding pin 74 for deforming the thermoplastic part 20, a cylinder rod adapter 76 which secures and orients the ejector 72 and molding pins 74. The cylinder rod adapter 76 is attached to a cylinder mating plug 78 at a distal end of the pin assembly portion 70. In one embodiment, the pin assembly portion 70 has at least three ejector pins 72, to create a plane for securing the thermoplastic part 20 during the staking cycle, and the molding pin 74 is located in the center of the ejector pins 72. Additionally, the pin assembly portion 70 is slidably moveable along an axis toward and away from a thermoplastic part 20 within the cradle 30.

The positive displacement heat stake apparatus of the present invention has a cylinder mating plug 78 partially received in the first end 62 of the sliding tube portion 60, and an insulating element 90 of machineable ceramic, partially received in the second end 64 of the sliding tube portion 60, and a mold 92 having channels for passage of the ejector pins 72 and the molding pins 74 during the staking cycle, where the mold 92 is connectively attached to the insulating element 90, in vertical alignment with the sliding tube portion 60. The mold 92 is made of a conductive material such as copper or the like. Additionally, a retaining clip 94 is located near the second end 64 of the sliding tube portion 60 for retaining the elements of the second end 64.

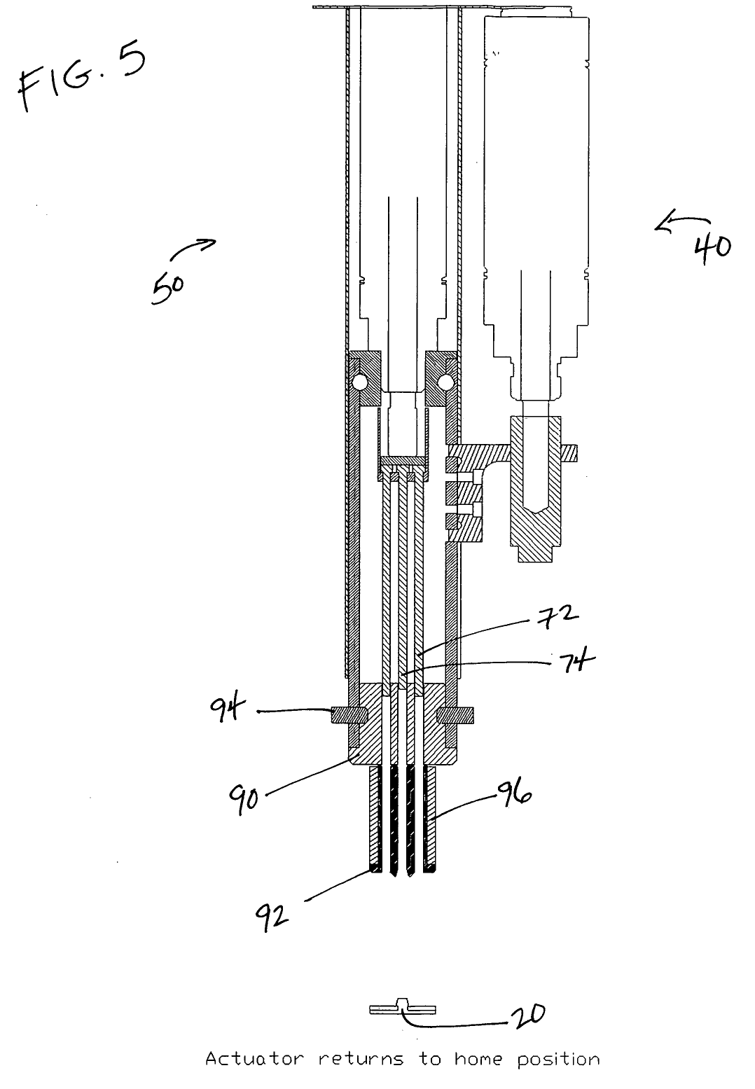

FIG. 5 illustrates that the heating source for the present invention is a band-type heater 96 attached to the mold 92, with the band-type heater 96 against an outer surface of the mold 92 to provide heat to the pins 72, 74, which is all coupled to a temperature gauge 98 (not shown) which monitors the temperature of the heating source.

The method of deforming a thermoplastic part using the positive displacement heat staking apparatus of the present invention comprises the steps of positioning the thermoplastic part in the cradle, heating the mold and pins conductively through the band-type heater, performing the heat staking cycle, and advantageously ejecting the thermoplastic part from the cradle.

In summary, numerous benefits have been described which result from employing the concepts of the invention. The foregoing description of one or more embodiments of the invention has been presented for purposes of illustration and description. It is not intended to be exhaustive or to limit the invention to the precise form disclosed. Obvious modifications or variations are possible in light of the above teachings. The one or more embodiments were chosen and described in order to best illustrate the principles of the invention and its practical application to thereby enable one of ordinary skill in the art to best utilize the invention in various embodiments and with various modifications as are suited to the particular use contemplated. While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A positive displacement heat stake apparatus for deforming a thermoplastic part comprising:
an actuator cylinder portion selectively actuable to produce movement toward and away from said thermoplastic part during a staking cycle,
a staking portion responsive to said actuator cylinder portion, said staking portion comprising:
an elongate housing coupled to the actuator portion and including a channel slot,
a sliding tube portion received by the elongate housing, said sliding tube portion having a first end and a second end and including a receiving means;
a pin assembly portion,
a staking cylinder longitudinally engaging said pin assembly portion; wherein said staking cylinder moves in concert with actuator cylinder portion during said staking cycle;
a cradle for orienting and supporting said thermoplastic part;
an actuator mount for connecting the actuator cylinder portion to said staking portion, in communication through said receiving means through said channel slot, whereby said pin assembly portion is slidably moveable along an axis toward and away from said thermoplastic part within said cradle;
a retaining clip located near said second end of said sliding tube portion; and
a heating source, for heating a portion of said thermoplastic part.

2. The positive displacement heat stake apparatus of claim 1, wherein the actuator cylinder portion further comprises a cylinder and rod operatively connected to said sliding tube portion, the rod being moveable between a first position, in which said sliding tube portion is in a home position, away from said thermoplastic part within said cradle, and a second position, in which the sliding tube portion is placed in a lowered position toward or in contact with said thermoplastic part within said cradle.

3. The positive displacement heat stake apparatus of claim 1, wherein the pin assembly portion further comprises a plurality of ejector pins oriented to engage, stabilize, and eject said thermoplastic part after said staking cycle, at least one molding pin for deforming said thermoplastic part, a cylinder rod adapter for removably securing and orienting said plurality of ejector and at least one molding pin(s), whereby said cylinder rod adapter is attached to said cylinder mating plug at a distal end of said pin assembly portion.

4. The positive displacement heat stake apparatus of claim 3, wherein the pin assembly portion has at least three ejector pins.

5. The positive displacement heat stake apparatus of claim 4, wherein the at least one molding pin is located in the center of said at least three ejector pins.

6. The positive displacement heat stake apparatus of claim 1, wherein the sliding tube portion further comprises a cylinder mating plug partially received in said first end of said sliding tube, and an insulating element partially received in said second end of said sliding tube, and a mold having channels for passage of said ejector pins and said molding pins during said staking cycle, said mold connectively attached to said insulating element, in vertical alignment with said sliding tube.

7. The positive displacement heat stake apparatus of claim 6, wherein the mold is made of a conductive material.

8. The positive displacement heat stake apparatus of claim 7, wherein the mold is made of copper.

9. The positive displacement heat stake apparatus of claim 1, wherein the thermal insulating element is a machineable ceramic.

10. The positive displacement heat stake apparatus of claim 1, wherein the elongate housing is made of stainless steel.

11. The positive displacement heat stake apparatus of claim 1, wherein the heating source is a band-type heater attached to said mold, with said band-type heater against an outer surface of said mold to provide heat to said pins, and whereby a temperature gauge monitors the temperature of said heating source.

12. The positive heat stake apparatus of claim 2, wherein the actuator cylinder portion further comprises a pneumatic or hydraulic cylinder.

13. The positive heat stake apparatus of claim 3, wherein the plurality of ejector pins provide positive ejection of the thermoplastic part from the mold.

14. The method of deforming a thermoplastic part using the positive displacement heatstaking apparatus of claim 1, comprising the steps of:
positioning the thermoplastic part in the cradle;
heating the mold and pins conductively through the band-type heater;
performing the heatstaking cycle; and
ejecting the thermoplastic part from the cradle.
